(19) United States
(12) Patent Application Publication
(10) Pub. No.: US 2007/0224315 A1
(43) Pub. Date: Sep. 27, 2007

(54) EXTRACTING ENZYMES FROM RAW MATERIALS

(75) Inventor: Tomas Carlsson, Lesja (NO)

Correspondence Address: FISH & RICHARDSON P.C., PO BOX 1022, MINNEAPOLIS, MN, 55440-1022, US

(73) Assignee: AMINOTECH AS, Lesja (NO)

(21) Appl. No.: 11/678,543

(22) Filed: Feb. 23, 2007

Related U.S. Application Data
(60) Provisional application No. 60/776,387, filed on Feb. 24, 2006.

(51) Int. Cl. A23F 3/16

(52) U.S. Cl. 426/52

(57) ABSTRACT

The present technology relates to a method for extracting enzymes from an enzyme-containing raw material, an enzyme composition obtainable by the method, and to the use of the enzyme composition for the hydrolysis of proteins or as a food supplement. Further, the present technology relates to a method for producing a protein hydrolysate from a protein-containing raw material.

### CLAIM OF PRIORITY

The instant application claims the benefit of priority to provisional application Ser. No. 60/776,387, filed Feb. 24, 2006, the content of which is hereby incorporated by reference in its entirety.

### TECHNICAL FIELD

The present technology relates to a method for extracting enzymes from an enzyme-containing raw material, an enzyme composition obtainable by the method and to the use of the enzyme composition for the hydrolysis of proteins or as a food supplement. Further, the present technology relates to a method for producing a protein hydrolysate from a protein-containing raw material.

### BACKGROUND

Methods of hydrolyzing proteins are well known in the art. Conventionally, protein hydrolysates are produced chemically by way of acidic hydrolysis. The resulting hydrolysates are inexpensive and can have satisfactory organoleptic properties. However, chemical hydrolysis is often accompanied by undesirable non-specific side reactions.

Enzymatic hydrolysis of proteins is an alternative to chemical hydrolysis. French Patent No. FR 2,168,259 proposes an enzymatic hydrolysis of fish proteins which is carried out by crushing fresh fish to a uniform mass without adding water. Exogenous enzymes are then added to the mass, and the mass is hydrolyzed for approximately 15 hours depending on desired solubility. The process yields products with high nutritional value.

Russian Patent No. RU 2,103,360 proposes a method for producing a proteolytic hydrolysate comprising using wastes of bodies of commercial fishes comminuted with fish intestines in an alkali medium. The mixture is mixed with distilled water in a ratio of 1:1 and subjected to hydrolysis at 40-42° C. until the weight fraction of amine-bound nitrogen reaches 5.5-5.6%, and that of free amino acids, 50-60%.

International Publication No. WO91/18520 proposes a method for producing a proteolytic hydrolysate, wherein raw protein-comprising animal parts are reduced to a ground condition. The ground material is then partly hydrolysed by the use of proteolytic enzymes, wherein the enzymes may be endogenous to the raw protein-comprising animal parts.

European Patent No. EP 1227736 proposes a method for producing a protein hydrolysate from a natural protein-containing raw material, wherein an aqueous slurry comprising 1-100% wet weight of the protein-containing material is incubated with a proteolytic composition derived from a Gadidae species. The slurry is then agitated for 0.25 to 48 hours at a temperature in the range of 0 to 60° C. in order to obtain the protein hydrolysate. The proteolytic composition is additionally described as being provided by a process, wherein water is mixed with fish viscera, and the resulting mixture is then agitated for a period of 0.5 hours or longer.

Norwegian Patent No. NO 320964 discloses a process for the production of a hydrolysed marine protein product, wherein by-product from fish and/or other marine industries/sources are first homogenized and then subjected to a controlled hydrolysis of the proteins by the use of naturally occurring enzymes and/or bacteria, particularly those that are present in the stomach-intestinal canal in fish. The obtained hydrolysate is then filtrated, by the use of ultrafiltration (UF), to provide a UF permeate containing hydrolyzed proteins and a UF concentrate containing oil, fat, emulsions, fibres and other large molecules. The UF permeate is then filtrated further, by the use of nanofiltration (NF), to provide a NF permeate containing water, monovalent ions and biogenic amines, and a NF concentrate containing hydrolyzed proteins. The UF concentrate and the NF concentrate are then concentrated separately or in combination by spray, vacuum or any other drying method. It is mentioned that the NF permeate containing water, monovalent ions and biogenic amines is not used. Based on the size of biogenic amines, it is likely that the NF permeate also contains significant amounts of free amino acids. Further, it should be noted that about 50% (dry weight) of the peptides/amines is lost during the nanofiltration step, and that the end product contains significant amounts of proteins.

Norwegian Patent No. NO 317900 discloses a method for producing a protein-free product comprising free amino acids and short peptides, wherein raw protein materials are crushed and hydrolysed with endogenous enzymes and passed through different separation processes in order to obtain the desired product.

According to the foregoing, a number of techniques for extraction of enzymes from organisms such as fish are known. In particular, the use of enzymes for the hydrolysis of proteins from fish are also a part of the state of the art.

### SUMMARY

An object of the present technology is to provide a method for extraction of naturally occurring enzymes from an enzyme-containing raw material, wherein the quantity of extractable enzymes are increased compared to what is disclosed in the art. Some of the enzymes that are released by the method described herein are in inactive form (e.g., zymogens). With that, it is also an object of the present technology to provide a method to render the inactive enzymes active.

It is further a purpose of the present technology to utilize the raw materials as fully as possible, and that the impact on the environment in connection with production is as low as possible.

Thus, a first aspect of the present technology relates to a method for extracting enzymes from an enzyme-containing raw material, the method comprising:
a) grinding the raw material to produce a ground raw material;
b) adjusting the pH of the ground raw material to a pH>7; and
c) expanding the ground raw material in order to extract the enzymes

Preferred embodiments of the method according to the first aspect are further set forth herein.

A second aspect of the present technology relates to a method for producing a protein hydrolysate from a protein-containing raw material, the method comprising:
a) grinding the raw material to produce a ground raw material;
b) adjusting the pH of the ground raw material to a pH>7;
c) expanding the ground raw material and/or adding the enzyme composition obtainable by the method according to the first aspect of the present technology; and
d) agitating the raw material for a time period and at a temperature that is sufficient to produce a protein hydrolysate.

Preferred embodiments of the method according to the second aspect are further set forth herein.

A third aspect of the present technology relates to an enzyme composition that is obtainable by the method according to the first aspect of the present technology. In particular, the enzyme composition may be distinguishable from other compositions known in the art in a manner that is directly attributable to having been obtained by the methods described herein.

A fourth and a fifth aspect of the present technology relates to the use of an enzyme composition according to the third aspect of the present technology for the hydrolysis of proteins and as a food supplement respectively.

In particular, the fourth aspect of the present technology includes a method of hydrolysing a protein, the method comprising applying the enzyme composition of the third aspect to the protein. Furthermore, the fifth aspect of the present technology includes a food supplement that comprises the enzyme composition according to the third aspect.

As mentioned hereinabove, an object of the present technology is to provide a method for extracting a naturally occurring enzyme or enzymes from an enzyme-containing raw material, wherein the quantities of extractable enzymes are increased compared to what has previously been achieved in the art. This is solved, for example, by expanding the ground raw material.

Furthermore, it is an object of the present technology to provide a method to render any inactive enzymes active. This is achieved by adjusting the pH and the temperature of the ground raw material to a pH and a temperature that is suitable for initiating activation of serine proteases contained therein.

None of the publications cited hereinabove mention that the release of endogenous enzymes can be facilitated by expanding the ground enzyme-containing raw material. It is possible to extract enzymes from the walls of the inner organs, where a larger quantity of enzymes is found compared to in the guts, by expanding the enzyme-containing raw material. Furthermore, some of the extracted enzymes are in inactive form, and are preferably activated before use. The activation of the inactive enzymes is neither disclosed in any of the documents cited hereinabove.

By using the increased amount of the extracted enzymes in a process for the production of a protein hydrolysate, degradation of the protein-containing raw material can efficiently be achieved in around 0.3-4 hours, as compared to 48 hours in other processes used in the art.

### BRIEF DESCRIPTION OF THE FIGURES

FIG. 1: The set-up of a plant illustrating a first part (part 1 of 3) of one embodiment according to the present technology (the reference numbers and letters in the figure are defined in table 1, herein).

FIG. 2: The set-up of a plant illustrating a second part (part 2 of 3) of one embodiment according to the present technology (the reference numbers and letters in the figure are defined in table 2, herein).

FIG. 3: The set-up of a plant illustrating a third part (part 3 of 3) of one embodiment according to the present technology (the reference numbers and letters in the figure are defined in table 3, herein).

FIG. 4: An alternative set-up of the plant illustrated in FIG. 2 (the reference numbers and letters in the figure are defined in table 4, herein).

FIG. 5: Example of a production scenario using 225,000 kg raw materials.

FIG. 6: The set-up of a plant where the hydrolysation process according to one embodiment herein is utilized (the reference numbers and letters in the figure are defined in table 5, herein).

### DETAILED DESCRIPTION

A first aspect of the present technology relates to a method for extracting enzymes from an enzyme-containing raw material, the method comprising:
a) grinding the raw material to produce a ground raw material;
b) adjusting the pH of the ground raw material to a pH>7; and
c) expanding the ground raw material in order to extract the enzymes.

A second aspect of the present technology relates to a method for producing a protein hydrolysate from a protein-containing raw material, the method comprising:
a) grinding the raw material to produce a ground raw material;
b) adjusting the pH of the ground raw material to a pH>7;
c) expanding the ground raw material and/or adding the enzyme composition obtainable by the method according to the first aspect of the present technology; and
d) agitating the raw material for a time period and at a temperature that is sufficient to achieve a protein hydrolysate.

Extracting enzymes from an enzyme-containing raw material does not necessarily mean that the enzymes are separated from the raw material, but merely that the enzymes are released from the raw material. One example of an enzyme extraction method is a grinding process as further described herein. Another example of an enzyme extraction method is a process of expanding the ground raw materials, as also described herein.

In one embodiment of the present technology, the protein-containing and the enzyme-containing raw materials are independently:
a marine organism material, such as fish, shellfish, molluscs or jellyfish;
by-products from marine organisms or marine organism processing plants, for example fish guts;
of animal origin, e.g., a cold blooded animal;
or any combinations thereof.

Preferably, the protein-containing and/or enzyme-containing raw material are/is a marine organism material or by-products from marine organisms/marine organism processing plants.

The protein-containing raw material may or may not be the same as the enzyme-containing raw material. In case the protein-containing raw material is of animal origin, the enzyme-containing raw material is preferably a marine organism material or by-products from marine organisms/marine organism processing plants.

The enzyme-containing raw material is a raw material which contains endogenous enzymes. Preferably, the endogenous enzymes in the enzyme-containing raw material are in adequate quantity and quality. However, it should be noted that the requirements with regard to quantity and quality of the enzymes in the enzyme-containing raw material is lower when the enzymes are used in a process wherein the enzymes are recycled within the process compared to when the enzymes are used in a process without recycling of the enzymes.

The term endogenous enzymes in relation to the protein-containing-material is used as a term for the enzymes naturally occurring in the protein-containing-material. With that, the term endogenous enzymes in relation to the enzyme-containing raw material is used as a term for the enzymes naturally occurring in the enzyme-containing raw material. As opposed to endogenous enzymes, exogenous enzymes is used as a term for enzymes that are neither naturally occurring in the protein-containing-material, nor in the enzyme-containing material.

In case the protein-containing raw material and/or the enzyme-containing raw material are/is a marine organism orby-products from marine organisms, the marine raw materials are preferably taken directly from the food processing operation or fishing vessel into special cooled food grade containers, where vacuum is used to reduce air contact. The cooling and the use of vacuum helps maintaining freshness during storage and transportation.

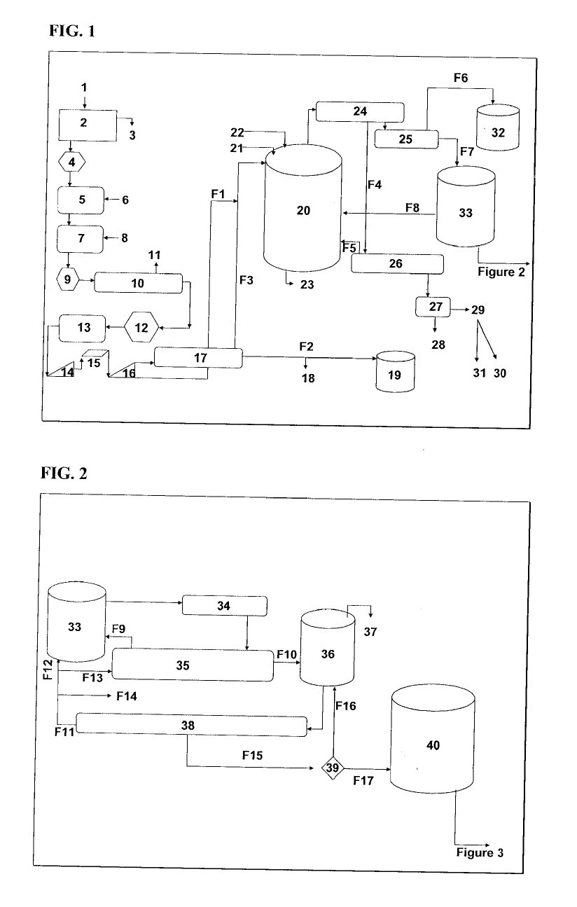

The ensuing description herein is made in conjunction with the various figures. Reference numerals in FIG. 1 are identified according to the schedule in Table 1.

TABLE 1

| No | Element |
|---|---|
| 1 | Raw material |
| 2 | Container |
| 3 | Sampling for: visual inspection, free fatty acids, raw protein, |
| | fat content and pH |
| 4 | Pump |
| 5 | Pre-grinding |
| 6 | pH adjustment |
| 7 | Macerator |
| 8 | Pre-heating |
| 9 | Pump |
| 10 | Expansion pipe |
| 11 | Pressure |
| 12 | Pump |
| 13 | Micro grinder |
| 14 | Decanter |
| 15 | Heat exchange |
| 16 | Decanter |
| 17 | Separator |
| 18 | Sampling for: water content, protein content and free fatty |
| | acids |
| 19 | Cold virgin oil storage tank |
| 20 | Bio-reactor |
| 21 | pH adjustment |
| 22 | Water |
| 23 | Sampling for: enzyme activity, amino nitrogen, protein content, |
| | fat content |
| 24 | Solid shifter separator |
| 25 | Separator |
| 26 | Flotation, separation of bone |
| 27 | Bone fraction |
| 28 | Drying and packing |
| 29 | Sampling for: metal and protein content |
| 30 | Fertilizer grade |
| 31 | Food grade |
| 32 | Industrial oil storage tank |
| 33 | Buffer tank (liquid phase) |
| No. | Flow Description |
| F1 | Particle suspension, separated from the liquid phase by the use |
| | of a decanter (14, 16) |
| F2 | Cold virgin oil, separated from the liquid phase by the use of |
| | a separator (17) |
| F3 | Liquid phase, separated from the virgin oil by the use of a |
| | separator (17) |
| F4 | Solids and residual protein separated from the liquid phase by |
| | the use of a solid shift separator (24) |
| F5 | Residual proteins, separated by the use of a flotation unit |
| | (26), are recycled back to the bio reactor (20) |
| F6 | Industrial oil, separated from the liquid phase by the use of a |
| | separator (25) |
| F7 | Liquid phase, separated from the industrial oil by the use of a |
| | separator (25) |
| F8 | Non-hydrolysed proteins/partly hydrolyzed proteins are recycled |
| | back to the bio reactor (20) |

Reference numerals in FIG. 2 are identified according to the schedule in Table 2.

TABLE 2

| No | Element |
|---|---|
| 33 | Buffer tank (liquid phase) |
| 34 | UV-treatment |
| 35 | Membrane filter (ultra filter) |
| 36 | Buffer tank |
| 37 | Sampling for: amino nitrogen, peptide length, dry matter |
| 38 | Membrane filter (nano filter) |
| 39 | Concentration control unit |
| 40 | Wet product storage tank |
| No. | Flow Description |
| F9 | Non-hydrolysed proteins and partly hydrolyzed proteins, |
| | separated by membrane filtration (35), are recycled back to the |
| | buffer tank (33) or back to the bio reactor (FIG. 1(20)) |
| F10 | Small peptides and amino acids, separated by membrane |
| | filtration (35), are transported to a buffer tank (36) |
| F11 | Permeate, mainly consisting of water and minerals, is either |
| | recycled back to the buffer tank (33) (F12), to the permeate |
| | side of the membrane filter (35) (F13), removed from the |
| | process (F14) or recycled back to the bio reactor (FIG. 1(20)) |
| F12 | See F11 |
| F13 | See F11 |
| F14 | See F11 |
| F15 | Fraction of peptides and amino acids that do not pass through |
| | the membrane filter (38) |
| F16 | In case the concentration of peptides and amino acids are too |
| | low, the concentrate is recycled back to the buffer tank (36). |
| F17 | In case the concentration of peptides and amino acids are OK, |
| | the concentrate is transported to a wet product storage tank |
| | (40) |

Reference numerals in FIG. 3 are identified according to the schedule in Table 3.

TABLE 3

| No | Element |
|---|---|
| 40 | Wet product storage tank |
| 41 | Small spray dryer |
| 42 | Storage Silo |
| 43 | Big bag |
| 44 | Bag-in-box |
| 45 | Large dryer |
| 46 | Granulation and agglomeration |
| 47 | Quality control |
| 48 | Reprocess or alternative use |
| No. | Flow Description |
| F18 | The concentrated peptide/amino acid fraction is transported |
| | to a small dryer (41) (F18) and/or to a large dryer (45) (F19) |
| F19 | See F18 |

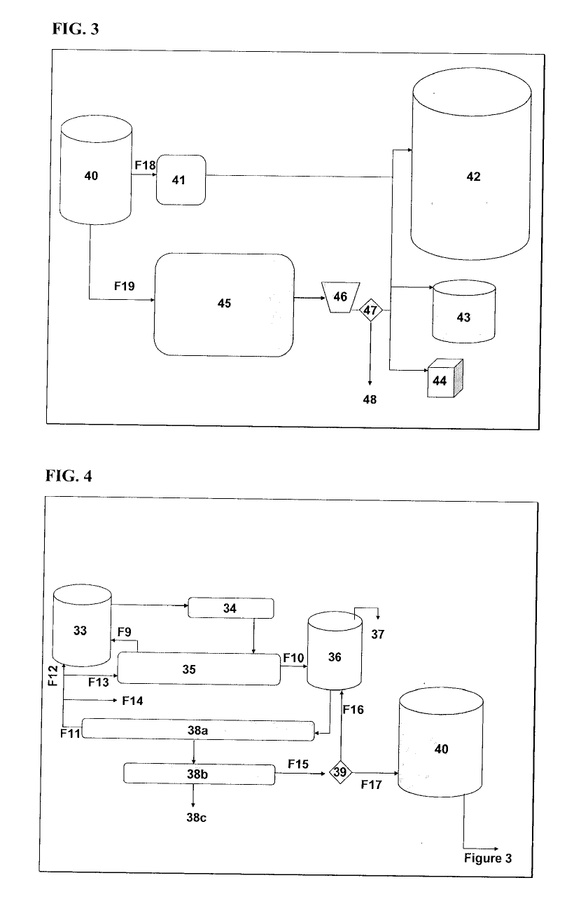

Reference numerals in FIG. 4 are identified according to the schedule in Table 4.

TABLE 4

| No | Element Description |
|---|---|
| 33 | Buffer tank (liquid phase) |
| 34 | UV-treatment |
| 35 | Membrane filter (ultra filter) |
| 36 | Buffer tank |
| 37 | Sampling for: amino nitrogen, peptide length, dry matter |
| 38a | Membrane filter (RO filter) |
| 38b | Membrane filter (OS filter) |
| 38c | Permeate, mainly consisting of minerals |
| 39 | Concentration control unit |
| 40 | Wet product storage tank |
| No. | Flow Description |
| F9 | Non-hydrolysed proteins and partly hydrolyzed proteins, |
| | separated by membrane filtration (35), are recycled back to the |
| | buffer tank (33) or back to the bio reactor (FIG. 1(20)) |
| F10 | Small peptides and amino acids, separated by membrane |
| | filtration (35), are transported to a buffer tank (36) |
| F11 | Permeate, mainly consisting of water, is either recycled back |
| | to the buffer tank (33) (F12), to the permeate side of the |
| | membrane filter (35) (F13), removed from the process (F14) or |
| | recycled back to the bio reactor (FIG. 1(20)) |
| F12 | See F11 |
| F13 | See F11 |
| F14 | See F11 |
| F15 | Fraction of peptides and amino acids that do not pass through |
| | the reverse osmosis filter (38a) nor the osmosis filter (38b) |
| F16 | In case the concentration of peptides and amino acids are too |
| | low, the concentrate is recycled back to the buffer tank (36). |
| F17 | In case the concentration of peptides and amino acids are OK, |
| | the concentrate is transported to a wet product storage tank (40) |

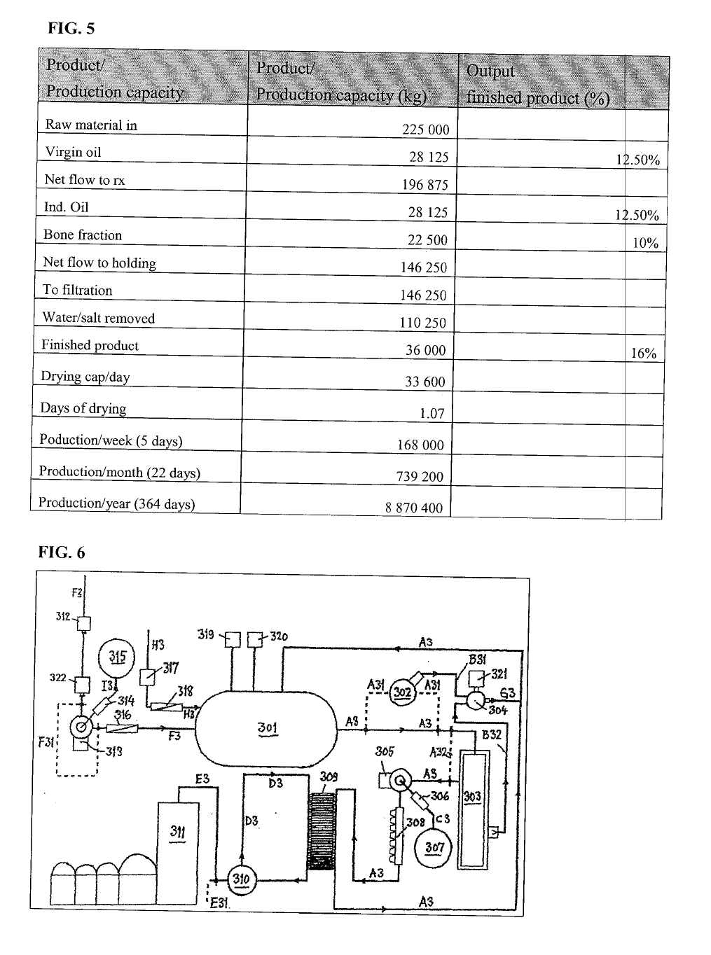

Reference numerals in FIG. 6 are identified according to the schedule in Table 5.

TABLE 5

| No | Element Description |
|---|---|
| 301 | Bio reactor |
| 302 | Separation unit for the removal of solid particles, preferably |
| | a screen separation unit (303), preferably a centrifuge of the |
| | decanter type |
| 304 | Flotation tank for separating proteins and hydroxy apatite |
| 305 | Separation unit for separating off oil, preferably a centrifuge |
| 306 | Filter unit for sterile filtration |
| 307 | Tank for oil/fat |
| 308 | Microorganism reduction unit |
| 309 | Membrane filter unit |
| 310 | Concentration unit |
| 311 | Drying unit |
| 312 | Grinding equipment |
| 313 | Centrifuge, preferably of the decanter type |
| 314 | Oil filter |
| 315 | Tank for oil recovered prior to the hydrolysation step |
| 316 | Heat exchanger for heating raw materials |
| 317 | Calcium dosing unit |
| 318 | Heat exchanger for heating the water |
| 319 | Device for supplying bone meal |
| 320 | Device for adding nitrogen |
| 321 | Container for recovered bone fraction |
| 322 | Expansion equipment |
| No. | Flow Description |
| A3 | Stream including proteins, enzymes, oil/fat, peptides and free |
| | amino acids |
| A31 | Stream if separation unit 302 is used; after the unit 302 the |
| | stream no longer contains solid particles |
| A32 | Stream if separation unit 303 is not used |
| B31 | Stream including solids removed using screen |
| B32 | Stream including solids separated using centrifuge |
| C3 | Stream including oil/fat |
| D3 | Stream of distillate or the like for release of permeate from |
| | the membrane filter 309 |
| E3 | Stream of concentrated peptide-amino acid solution to the |
| | drying unit |
| E31 | Stream of concentrated peptide-amino acid solution to packing |
| | as a liquid product |
| F3 | Stream of raw materials to the bio reactor 301 |
| F31 | Stream of raw materials when oil separation does not take place |
| | before the hydrolysis |
| G3 | Stream of non-hydrolysed proteins returning to stream A3 |
| H3 | Stream of added water |
| I3 | Stream of oil recovered before the hydrolysation step |

The grinding process (illustrated in FIG. 1 (items 5, 13) and FIG. 6 (item 312)) provides larger surface area for the enzymes, as well as releasing the enzymes from the raw materials. With that, the raw materials may be ground to relatively large particles, but it is preferred that the raw materials are ground to small particles, and even more preferred to particles of the smallest achievable size, e.g., to a particle size of 1 mm or less, to a particle size of 0.5 mm or less, or to a particle size of 0.1 mm or less. For example, a micro-grinder may be employed for this purpose.

In case the ground raw material is stored before further processing, the ground raw material should preferably be cooled to a temperature lower than 10° C., and more preferably to a temperature lower than 4° C.

The optimum pH of operation of the enzyme pepsin, which may be present in the raw materials, is around 3, and the activity of pepsin is almost entirely blocked at a pH>7. Normally, activated pancreas enzymes are hydrolyzed in a dead fish by hydrochloric acid and pepsin from the fish stomach. Some fish, such as salmon, have no specific pancreas glands, but have instead groups of small acinar cells around pylorus blind sacs. Blocking pepsin activity is important because pepsin naturally destroys the enzyme enterokinase which itself is important for degradation of the raw materials through activation of the serine protease system. Thus, it is advantageous that the pH is greater than 3, preferably greater than 7, in the ground raw material mixture when the unstable enterokinase is released. This may be achieved by addition of sufficient amounts of a pH regulating agent, e.g., NaOH, to the ground raw material (illustrated in FIG. 1 (item 6)).

The release of the enzymes, including the serine protease system, is further facilitated by expanding the ground raw materials. The process of expanding the ground raw materials should be understood as a process wherein the ground raw materials experience a drop in pressure, e.g., a pressure drop in the range 0.1 bar to 5 bar, 0.5 bar to 3 bar, 0.1 bar to 2 bar, or 1 to 2 bar. This may be achieved by having a pump (FIG. 1 (item 9)) before an expansion pipe that provides a constant flow of ground raw materials, and a high capacity pump (FIG. 1 (item 12)) after the expansion pipe that provides a pulse flow of the ground raw materials. With that, the ground raw materials in the expansion pipe (FIG. 1 (item 10)) experience a pulsing negative pressure that facilitates the release of the enzymes. The maximum absolute pressure in the expansion pipe minus the minimum absolute pressure in the expansion pipe can be e.g., in the range 0.01 bar to 1 bar, in the range 0.1 bar to 0.7 bar, in the range 0.1 bar to 0.5 bar, or in the range 0.1 bar to 0.2 bar. The expansion step can be performed anywhere in between the grinding step (illustrated in FIG. 1 (item 5)) and the bio-reactor (illustrated in FIG. 1 (item 20)).

Since some of the enzymes released during the expansion step are in inactive form, the enzymes are preferably activated before use. The activation of the enzymes can be performed anywhere in between the grinding step (illustrated in FIG. 1 (item 5)) and the bio-reactor (illustrated in FIG. 1 (item 20)), preferably after or during the expansion step (illustrated in FIG. 1 (item 10)), and even more preferably after the oil extraction step (illustrated in FIG. 1 (item 17)). The enzymes can also be activated in the bioreactor (illustrated in FIG. 1 (item 20)).

In case the enzyme composition is to be stored for later use, the enzyme composition may be separated from the rest of the expanded ground raw material. The enzyme composition may optionally be concentrated. Further, the inactive enzymes may be activated before storage, or the enzyme composition may be stored as it is. The obtained enzyme composition can be frozen or dried e.g., by freeze-drying, or spray-drying. A third aspect of the present technology relates to the enzyme composition that is obtainable by the method according to the first aspect of the present technology.

A fourth and a fifth aspect of the present technology relate to the use of the enzyme composition according to the third aspect, for the hydrolysis of proteins and as a food supplement respectively. The enzyme composition according to the third aspect may contain DNAses and/or lipases and/or proteases.

A pH of 8.2 is the optimal point for the activity of the serine protease group. Accordingly, a pH that is suitable for initiating the activation of the serine proteases is in the range 7.0-9.0, preferably in the range 7.5-8.5, and most preferably a pH of 8.2.

Furthermore, the temperature of the ground raw material may be raised (as illustrated in FIG. 1 (item 8)) to a temperature <54° C., e.g., in the range 10-54° C., and preferably to a temperature in the range 10-30° C., e.g., 10-20° C. in order to speed up the process of activation. Accordingly, a temperature that is suitable for initiating the activation of the serine proteases is in the range 10-54° C., and preferably in the range 10-30° C., e.g., 10-20° C.

In one embodiment of the present technology the serine proteases are activated in the bio reactor (illustrated in FIG. 1 (item 20), and FIG. 6 (item 301)) with a temperature and a pH that are optimal for the hydrolysation process (described below). In another embodiment, according to the present technology, the serine proteases are activated before entering the bio-reactor, with a temperature and a pH that are optimal for initiating the activation of the serine proteases.

The essence of the serine protease system is that it cleaves peptide bonds without destroying amino-acids themselves. Key facets of the serine protease cascade are as follows: Enterokinase, e.g., from the pylorus wall, catalyzes the transformation of trypsinogen to trypsin, an endopeptidase. Trypsin then activates the rest of the serine protease system. Similarly, chymotrypsinogen is converted to chymotrypsin, and proelastase to elastase. The released trypsin can then act on other proteins in the ground raw materials: Kallikreinogen is converted to kallikrein; procarboxypeptidase A and B are converted to carboxypeptidase A and B, respectively; pro-RNAase and pro-DNAase are converted to RNAase and DNAase. Respectively in the lipase system, pro-colipase is converted to co-lipase; and pro-phospholipase is converted to phospholipase by trypsin. It is noted that if enterokinase that is unstable is destroyed, the whole serine protease system cannot be activated, i.e., it will stay in the inactivated not the functional form.

Thus, enzymes within the raw materials are harnessed within the process(es) described herein to break down other proteins into shorter chain peptides, and ultimately amino acids.

The RNA-ase and DNA-ase are important to the overall process: RNA and DNA from the raw materials may block the membranes described further hereinbelow; RNA-ase and DNA-ase thus make it easier to run the process(es) described herein because they break down RNA and DNA. It is also important that the final product contains no full RNA or DNA strands, for safety reasons.

In one useful embodiment of the technology, a first oil/fat product is separated from the ground raw material (illustrated in FIG. 1 (item 17) and FIG. 6 (items 313, and 314)), preferably before the temperature of the ground raw materials is raised, to speed up the activation of the serine proteases. A cold extraction of the oil can e.g., be achieved with the method described in example 1. In one possible production scenario, about 28,000 kg of virgin oil can be obtained from 225,000 kg of raw materials (FIG. 5), which gives an output of about 12%.

In another useful embodiment of the technology, water with similar temperature and pH value to that which is optimal for the hydrolyzation process is added before and/or during the agitation step (illustrated in FIG. 6 (items 317, 318, H3)). Alternatively, water is added and the pH and temperature in the resulting mixture is adjusted to that which is optimal for the hydrolyzation process (illustrated in FIG. 1 (items 21, 22)). Preferably, the optimal pH is in range 7.0-8.5 and most preferably in range 7.6-8.2. The pH-value may be adjusted by adding, for example NaOH. Preferably, the optimal temperature is <62° C., more preferably in the range 40-62° C., and most preferably in the range 37-58° C., or in the range 40-58° C. If pH is >8.1 but <8.4 during the whole process, the amino acid tryptophan is excluded from the amino acid profile, and alternatively if the pH is <7.6 but >7.4 during the whole process, the level of tryptophan is maximized, the maximum amount depending on levels present in the raw material. If the temperature is <46° C. but >44° C., and pH is <7.8 but >7.7 during the whole process, the collagen is not dissolved to a significant degree but precipitates as solid particles. The amount of water can be used to adjust concentration levels, and can be adapted to the raw material and the desired product(s).

The heated and pH-adjusted mixture of raw material and water is hereinafter referred to as hydrolysate. The hydrolysate may be kept in the bio reactor (illustrated in FIG. 6 (item 301))/bio reactor (illustrated in FIG. 1 (item 20)) with constant and aggressive stirring. The purpose of this is to improve the bulk efficiency of the enzymatic reaction.

In another useful embodiment of the technology, a pH-regulating agent is added to the hydrolysate. A pH-regulating agent may be chosen from a number of different compounds, or any combinations thereof, for example NaOH (illustrated in FIG. 1 (item 21), and FIG. 6 (items 319, 320)).

By means of the present technology, it is possible to continuously control the enzymatic process(es) by adjusting various parameters in order to keep the conditions at the optimal level. Examples of such parameters include temperature, pH, agitation/stirring speed, amount of water, etc., the various adjustments being within the capability of one of ordinary skill in the art.

In one useful embodiment of the technology, solid particles of a certain size can be separated from the hydrolysate either continuously or periodically (illustrated in FIG. 1 (item 24) and FIG. 6 (items 302, 303)). The separated particles may thereafter be further separated according to density by way of a floatation process (illustrated in FIG. 1 (item 26) and FIG. 6 (item 304)) so that residual protein can be recycled (illustrated in FIG. 1 (item F5), FIG. 6 (item G3)) to the bio-reactor (illustrated in FIG. 1 (item 20), FIG. 6 (item 301) respectively). Proteins float, and can be skimmed off mechanically or manually. The heavier material will settle in the bottom of the flotation tank. A decanter (illustrated in FIG. 6 (item 303)) can be integrated in the system before oil separation (illustrated in FIG. 1 (item 25), FIG. 6 (item 305) and the membrane filter (illustrated in FIG. 2 (items 35, 36) and FIG. 6 (item 309)). This is done to simplify the separation of fat from the hydrolysate in for example a three phase separator and thereby reduce the load on the following membrane filter. A separator does not operate optimally if the content of solid particles is too high, which again means that the sludge phase becomes too large. The decanter is a mechanism which is constructed to separate solid particles with higher density than the solution they are contained in.

In another useful embodiment of the technology, the solid particles are separated into hydroxy apatite, residual protein and other solid particles.

In one embodiment of the present technology it is brought forth a hydroxy apatite product characterized such that it does not contain allergens or trace nucleotides such as DNA. Hydroxyapatite is used in for example bio chromatography, and other bio-technological separation processes, in NMR and other detection processes, and is thus a commercially valuable by-product of the process.

In another useful embodiment of the technology, a second oil/fat product is periodically or continuously separated from the hydrolysate (illustrated in FIG. 1 (item 25), FIG. 6 (item 305)). The hydrolysate is separated, e.g., in a three phase separator or in an appropriate centrifuge device which is suitable to separate the lighter fat fraction from the hydrolysate. The separation of fat takes place continuously or periodically depending on the amount of fat in the raw material that is being processed. It is preferred that a very pure and high quality fat fraction can be extracted as the separation can be done in a continuous process where the fat which is separated is not exposed to oxidation longer than necessary, when the lipoproteins are split by the hydrolysis. The fact that the hydrolysis is taking place in basic solution will also contribute to keeping the fat quality high. In one possible production scenario, about 28,000 kg of industrial oil can be obtained from 225,000 kg of raw materials (FIG. 5), which corresponds to an output of about 12%.

In another embodiment of the present technology, the raw material, the ground raw material, the hydrolysate and/or the enzyme composition are/is treated against the growth of micro organisms (illustrated in FIG. 2 (item 34), FIG. 6 (item 308)). In the method according to this technology UV, or another appropriate method to kill bacteria and fungi is preferably used, which does not lead to coagulation of the enzymes. This is done to avoid that a rapid growth of micro organisms shall consume the extracted short peptides and free amino acids in the formation of new proteins.

In another embodiment of the present technology, the desired molecular weight fraction of peptides/amino acids are separated by way of membrane filtering (illustrated in FIG. 2 (item 35), FIG. 6 (item 309)), e.g., by ultrafiltration. In one embodiment, only molecules under 10,000 Dalton can penetrate the filter, and in another embodiment, only molecules from 100 to 8,000 Dalton or from 60 to 8,000 Dalton can penetrate the filter. In another embodiment of the technology, only molecules under 5,000 Dalton can penetrate the filter, preferably only molecules from 100 to 5,000 Dalton, or from 60 to 5,000 Dalton. The filtering can, e.g., be set up in a way where the hydrolysate is pumped through a number of pipe-shaped membranes or passed over a number of plane membranes. Those parts of the hydrolysate which do not penetrate the membrane filter are preferably recycled back to the agitation step (illustrated in FIG. 2 (F9)).

Preferably the membrane filtering is ultra filtration, and the membrane can be of, e.g., polysulphone type. Furthermore, the presence of enzymes (e.g., proteases and lipases) in the hydrolysate contributes to the dissolving of a possible coating on the membranes consisting of fat, proteins and peptides.

The principle of osmosis can be applied for transport through the membrane(s). The concentration (described hereinbelow) of free amino acids and peptides yields water as a by-product, and a part of this can be recycled to the filter with approximately same pressure as the hydrolysate on the other side of the membrane (illustrated in FIG. 2 (item F13), and FIG. 6 (item D3)). By maintaining the concentration of amino acids and peptides lower on the permeate side of the membranes, the osmotic penetration is maintained through the membrane. The flow of the hydrolysate along the membranes cleans them mechanically, thereby reducing the residue of proteins and peptides that are too large to penetrate the membranes.

A series of filters can be used to separate different fractions with regard to maximum peptide size, but in the following steps there is no support from the enzyme complex to keep the filter membranes free of the filter cake on the retinate side. Accordingly, enzymes can be added to the permeate in order to keep the filter membranes free of the filter cake on the retinate side.

In another useful embodiment of the present technology, the permeate is concentrated to achieve peptides/amino acids (illustrated in FIG. 2 (item 38), FIG. 6 (item 310)). This can be done by removing water before the drying step so that the capacity of the drying process is utilized optimally, or so that the concentration level of the incoming amino acids and peptides desired in a liquid product is achieved.

A distillation process of the type vacuum distillation/evaporation can be applied, but any type of concentration technique can be utilized to separate the desired peptides and amino acids from the solution they are a part of during the membrane filtering. Vacuum distillation concentrates the solution at a low temperature so that the peptides/amino acids are not destroyed. The vacuum distillation can take place in the temperature interval +50 to +85° C. Optimally it takes place in the interval +65 to +70° C. If osmosis is applied for transport through the membrane(s), the condensate can preferably be recycled back to the permeate side of the above mentioned membrane filter. The condensate may also be recycled back to the bio reactor. However, there is a risk that the condensate has too high a temperature to be recycled to the filter or the bio reactor. If this is the case, a heat exchanger reducing the temperature to the desired level should be used.

Even though vacuum distillation can be utilized, a preferred process for the removal of water and/or minerals is the use of nanofiltration (illustrated in FIG. 2 (item 38)) or the use of a reverse osmosis (RO) and/or osmosis (OS) filter. With that, another useful process for the removal of water and minerals is the use of a RO filter to remove water and the use of an OS filter to remove minerals (illustrated in FIG. 4 (items 38a, 38b)). Vacuum distillation, nanofiltration, OS and RO, may be utilized alone or in any combinations thereof.

In the concentration step, water and optionally minerals are removed without any significant loss of amino acids and/or peptides. With that, the amount (dry weight) of any biogenic amines (as defined in, e.g., Norwegian patent no. NO320964) that may be present in the final product will not be significantly reduced compared to the amount present in the hydrolysate.

In another useful embodiment of the present technology, the concentrated amino acid/peptide product can be dried (illustrated in FIG. 3 (items 41 and/or 45,46), FIG. 6 (item 311)), but it can also be kept in liquid form or in any form in between dry and liquid. The drying will give the product a longer shelf life and stability, and simplifies the logistics and handling. The method of drying is important for the end result. A finished peptide-/amino acid product can be very hygroscopic, and this property is a challenge with regard to this process. High temperature in the drying process will contribute to a more hygroscopic end product, and may result in crystallization of amino acids.

Drying/granulation can take place in two steps. In the first step the product is dried to a powder in a powder dryer or similar, with a cooling step; thereafter the product is granulated (illustrated in FIG. 3 (items 45, 46). The granulation is done by “building” granulates, keeping the powder/product in vigorous movement by way of mechanical fluidization. Subsequently, the concentrate/hydrolysate is sprayed into this mass, gradually building granules. This is a continuous process. At the end of the granulation process, dry cold air is blown over/through the granulate. This makes it more brittle and more soluble. The granulate is thereafter sieved, and the desired fraction is removed. Particles which still are too small are recycled for further granulation while “oversize” particles are reground and sieved again. Possible new dust will be recycled for re-granulation. During the granulation process, various additives can be incorporated in the product. Products that are not granulated can be produced as well as products that are not dried, but merely concentrated to a desired level. Conventional spray drying can also be used, but this produces a fine powder with a large surface area. As a result, the product is extremely hygroscopic, and therefore difficult to handle in large packaging, storage, etc. However, a person skilled in the art would recognize that any suitable drying method may be utilized.

At termination of the process it is preferred to inactivate the enzymes by way of temperature or other means in order to avoid formation of ammonia. The process should be considered terminated when the supply of raw material has stopped, and the amount of proteins in the bioreactor has reached a critical low value.

A sixth aspect of the present technology relates to a protein hydrolysate obtainable by the hydrolysate production method according to the present technology. In one possible production scenario, about 36,000 kg (dry weight) of finished amino acid/peptide product can be obtained from 225,000 kg (dry weight) of raw materials (FIG. 5), which gives an output of about 16% of the finished product.

Preferably, the protein hydrolysate, according to the sixth aspect of the present technology, contains less than 3% fat, more preferably less than 1% fat and most preferably less than 0.1% fat, and has low taste and odour. Further reduction of the taste and odour is possible e.g., by way of supercritical extraction (standard technique). It is also preferred that the protein hydrolysate is completely free of functional protein, genetic material, and other allergens. Further, the protein hydrolysate preferably contains an amount of free amino acids (expressed as the ratio: weight amino acids/weight dry product) in the range 5-95%, 20-95%, 50-95%, 70-95%, 30-70%, 40-60% or 50-60%.

A product according to the sixth aspect of the present technology can be a product with pharmaceutical, bio-technological, nutritional or feed qualities. By pharmaceutical quality is meant products for parenteral (intravenous) use, and products that are classified as medical products for use in humans or animals, or natural medicine. By bio-technological quality is meant products that can be used for example in culture media, or catalysts in cultures for cells, bacteria, fungi, and algae. By nutritional quality is meant products that are used for human consumption either as an additive or as a complete product. By feed quality is meant products that are used for feed products, in the form of an additive or as a complete product.

### EXAMPLES

### Example 1

### Cold Extraction of Oil

Cold extraction of the oil can be done in the following way:
a) Separate liquid and solid particles from the raw materials by way of centrifugation, e.g., in centrifuge (FIG. 6 (item 313)).
b) Separate the oil from the liquid phase, cf. (FIG. 6 (items 314, 315).
c) The solid phase and the heavy phase from the separation is mixed and pumped to the bio reactor (FIG. 6 (item 301)).
d) The oil phase from the separation is further treated to a finished customer specific product which does not require further refining to achieve food quality.

### Example 2

### Membrane Filtering

In trials the Spectra/Por 1 Regenerated Cellulose (RC) with Molecular Weight Cut-Off (MWCO) of 6,000 to 8,000 Dalton (6k to 8k MWCO) was used.

The flux through these membranes with total dry mass (TS) on the retinate side of 14.7% with a temperature of 48.7° C. and pH 7.85 was at start 3.7 ml/cm²/h. After 12 hours 3.8 ml/cm²/h, and after 24 hours 3.8 ml/cm²/h. Blocking could not be registered even after 60 hours of operation.

No molecules above 9,000 Dalton could be identified in the permeate in peptide size analysis before and after the concentration of the total of 23 liters of liquid with 36% TS which was produced in the space of 60 hours in total. Largest peak on the spectrogram was in the region of 410-1350 Dalton which without correction represents 42% of the area of the spectrogram.

What is claimed:

1. A method for extracting enzymes from an enzyme-containing raw material, the method comprising:
grinding the raw material to produce a ground raw material;
adjusting the pH of the ground raw material to a pH>7; and
expanding the ground raw material in order to extract the enzymes.

2. The method according to claim 1, wherein the adjusting the pH of the ground raw material further comprises:
adjusting the pH of the ground raw material to a pH that is suitable for initiating the activation of serine proteases contained in the raw material.

3. The method according to claim 1, the method further comprising:
adjusting the temperature of the ground raw material to a temperature that is suitable for speeding up the activation of serine proteases contained in the raw material.

4. The method according to claim 1, the method further comprising:
separating the enzymes, after the expanding;
optionally concentrating the enzymes; and
optionally drying the enzymes.

5. A method for producing a protein hydrolysate from a protein-containing raw material, the method comprising:
grinding the raw material to produce a ground raw material;
adjusting the pH of the ground raw material to a pH>7;
expanding the ground raw material and/or adding the enzyme composition obtainable by a method according to claim 1;
agitating the raw material for a time period and at a temperature that is sufficient to achieve a protein hydrolysate.

6. The method according to claim 5, the method further comprising:
periodically or continuously separating a first oil/fat product from the ground raw material.

7. The method according to claim 5, wherein the adjusting the pH of the ground raw material further comprises:
adjusting the pH of the ground raw material to a pH that is suitable for initiating the activation of the serine proteases.

8. The method according to claim 5, the method further comprising:
adjusting the temperature of the ground raw material to a temperature that is suitable for speeding up activation of the serine proteases.

9. The method according to claim 5, the method further comprising one or more of:
adding water with a similar temperature and pH value to that which is optimal for the hydrolyzing the protein; or
adding water and adjusting the temperature and pH value of the resulting mixture to that which is optimal for the hydrolyzing the protein.

10. The method according to claim 5, the method further comprising:
adding a pH-regulating agent to the hydrolysate.

11. The method according to claim 5, the method further comprising:
separating solid particles and residual proteins from the hydrolysate; and, optionally,
recycling the residual proteins back to the agitating step for further hydrolysis.

12. The method according to claim 5, the method further comprising:
periodically or continuously separating a second oil/fat product from the hydrolysate.

13. The method according to claim 5, the method further comprising:
treating the raw material, the ground raw material, the hydrolysate and/or the enzyme composition against the growth of micro organisms.

14. The method according to claim 5, the method further comprising:
separating the desired molecular weight fraction of peptides/amino acids by way of membrane filtering; and, optionally
recycling those parts of the hydrolysate which do not penetrate the membrane filter back to the agitating step.

15. The method according to claim 14, the method further comprising:
concentrating the permeate from the separating step, and, optionally
drying the concentrated peptide/amino acid product from the separating step.

16. The method according to claim 15, the method further comprising:
completely or partly recycling the permeate from the concentrating step to the permeate side of the membrane, or optionally back to the agitation step.

17. A method for producing a protein hydrolysate from a protein-containing raw material, the method comprising:
a) grinding the raw material;
b) adjusting the pH of the ground raw material to a pH>7;
c) expanding the ground raw material and/or adding the enzyme composition obtainable by the method according to claim 1;
d) optionally, periodically or continuously separating a first oil/fat product from the ground raw material;
e) optionally, adjusting the pH and the temperature of the ground raw material to a pH and a temperature that is suitable for initiating the activation of the serine proteases;
f) adding water with similar temperature and pH value to that which is optimal for the hydrolysation process, or adding water and adjusting the temperature and pH value of the resulting mixture to that which is optimal for the hydrolysation process;
g) agitating the raw material for a time period and at a temperature that is sufficient to achieve a protein hydrolysate;
h) optionally, adding a pH-regulating agent to the hydrolysate;
i) separating solid particles and residual proteins from the hydrolysate and optionally recycle said residual proteins back to step h) for further hydrolysis;
j) periodically or continuously separating a second oil/fat product from the hydrolysate;
k) treating the raw material, the ground raw material, the hydrolysate and/or the enzyme composition against the growth of micro organisms;
l) separating the desired molecular weight fraction of peptides/amino acids by way of membrane filtering and optionally recycling those parts of the hydrolysate which do not penetrate the membrane filter back to the step of separating solid particles and residual proteins;
m) concentrating the permeate from step l);
n) optionally, completely or partly recycling the permeate from step m) to the permeate side of the membrane in step l) or back to step h); and
o) optionally, drying the concentrated peptide/amino acid product from step n).

18. An enzyme composition obtainable by the method of claim 1.

19. A method of hydrolysing a protein, the method comprising:
applying the enzyme composition of claim 18 to the protein.

20. A food supplement comprising the enzyme composition according to claim 18.
